(19) United States
(12) Patent Application Publication
(10) Pub. No.: US 2026/0162865 A1
(43) Pub. Date: Jun. 11, 2026

(54) MAGNETIC COMPONENT AND FABRICATION METHOD THEREOF

(71) Applicant: Delta Electronics (Shanghai) CO., LTD., Shanghai (CN)

(72) Inventors: Linyan XIAO, Shanghai (CN); Yanwei HU, Shanghai (CN); Xueyong ZHAI, Shanghai (CN); HSIEH-SHEN HSIEH, Shanghai (CN)

(73) Assignee: Delta Electronics (Shanghai) CO., LTD., Shanghai (CN)

(21) Appl. No.: 19/180,201

(22) Filed: Apr. 16, 2025

(30) Foreign Application Priority Data
May 6, 2024 (CN) 2024105541303

(51) Int. Cl. H01F 7/20; H01F 3/00; H01F 7/127

(52) U.S. Cl. CPC H01F 7/20; H01F 3/00; H01F 7/127

(57) ABSTRACT

A magnetic component includes a magnetic device, a base and a positioning frame. The magnetic device has a top part and a bottom part arranged opposite to each other, and includes a magnetic core and a winding wound around the magnetic core. The base includes a base plate. The positioning frame has a positioning part and a peripheral wall, where a first end of the peripheral wall is perpendicularly connected to a peripheral edge of the positioning part. A second end of the peripheral wall of the positioning frame is connected to a peripheral edge of the base plate, causing the positioning frame and the base plate to jointly enclose an accommodating space. The magnetic device is located in the accommodating space. The top part of the magnetic device cooperates in a contacting manner with the positioning part of the positioning frame.

### CROSS-REFERENCE TO RELATED APPLICATION

The present application claims the benefit of priority to Chinese patent application No. 2024105541303, filed on May 6, 2024, the contents of which are incorporated herein by reference in their entireties for all purposes.

### TECHNICAL FIELD

The present disclosure relates to a magnetic component and a fabrication method thereof.

### BACKGROUND

When the magnetic component works, its magnetic core and winding generate a large amount of heat. The heat dissipation structure of the magnetic component generally consists of a heat dissipation adhesive, a heat dissipation aluminum plate, a coolant, etc. A portion of the heat generated by the magnetic component is emitted through the air, and another portion is introduced into the heat dissipation aluminum plate through the heat dissipation adhesive, and then taken away by the coolant.

In the prior art, due to fabrication tolerances and other reasons, the distance between the magnetic core or winding and the heat dissipation aluminum plate in each magnetic component is different, especially in different batches of magnetic components. The distance between the magnetic core or winding and the heat dissipation aluminum plate varies considerably, resulting in different heat dissipation effects.

By way of example, as shown in FIG. 1, in the magnetic component 1A, the winding 12 is wound on the magnetic core 11 with a large tolerance, and the distance D1 between the top part of the magnetic component 1A and the heat dissipation aluminum plate 100 of the client is small.

In the magnetic component 1B, the winding 12 is wound on the magnetic core 11 with a small tolerance, and the distance D2 between the top part of the magnetic component 1B and the heat dissipation aluminum plate 100 of the client is large. That is, due to the different winding tolerances, the distances between the two magnetic components 1A, 1B and the heat dissipation aluminum plate 100 of the client shown in FIG. 1 are different, resulting in different lengths of heat dissipation channels. Therefore, the heat dissipation effects of the two magnetic components 1A, 1B are different.

### SUMMARY

A main object of the present disclosure is to provide a magnetic component with a good and high consistency heat dissipation effect, and a fabrication method thereof.

In order to achieve the above object of the application, the present disclosure adopts the following technical solutions.

According to an aspect of the present disclosure, a magnetic component includes:
a magnetic device, having a top part and a bottom part arranged opposite to each other, where the magnetic device includes a magnetic core and a winding wound around the magnetic core;
a base, including a base plate; and
a positioning frame, having a positioning part and a peripheral wall, and the peripheral wall includes a first end and a second end arranged opposite to each other, where the first end and the second end correspond to the top part and the bottom part of the magnetic device respectively, and the peripheral wall is perpendicularly connected to a peripheral edge of the positioning part via the first end; where
the second end is connected to a peripheral edge of the base plate, causing the positioning frame and the base plate to enclose an accommodating space; the magnetic device is located in the accommodating space; and the top part of the magnetic device cooperates in a contacting manner with the positioning part.

According to another aspect of the present disclosure, a fabrication method of a magnetic component includes the following steps:
a step of providing a magnetic device, where the magnetic device has a top part and a bottom part arranged opposite to each other, and the magnetic device includes a magnetic core and a winding wound around the magnetic core;
a step of providing a base, where the base includes a base plate;
a step of providing a positioning frame, where the positioning frame has a positioning part and a peripheral wall; the peripheral wall includes a first end and a second end arranged opposite to each other, where the first end and the second end correspond to the top part and the bottom part of the magnetic device respectively, and the peripheral wall is perpendicularly connected to a peripheral edge of the positioning part via the first end; the second end of the peripheral wall is connected to a peripheral edge of the base plate, thereby causing the positioning frame and the base plate to enclose an accommodating space; and the magnetic device is located in the accommodating space; and
a positioning step, where an assembly jig is used to push the magnetic device by passing through a jig hole on the base, thereby causing the top part of the magnetic device to cooperate in a contacting manner with the positioning part of the positioning frame.

According to another aspect of the present disclosure, a fabrication method of a magnetic component includes the following steps:
a step of providing a magnetic device, where the magnetic device has a top part and a bottom part arranged opposite to each other, and the magnetic device includes a magnetic core and a winding wound around the magnetic core;
a step of providing a base, where the base includes a base plate;
a step of providing a positioning frame, where the positioning frame has a peripheral wall; the peripheral wall includes a first end and a second end arranged opposite to each other, where the first end and the second end correspond to the top part and the bottom part of the magnetic device respectively, and the second end is connected to a peripheral edge of the base plate, thereby causing the positioning frame and the base plate to enclose an accommodating space; and the magnetic device is located in the accommodating space;
a step of providing an assembly jig, where the assembly jig includes a positioning structure and a force applying pillar, and the peripheral wall is perpendicularly connected to a peripheral edge of the positioning structure via the first end; and
a positioning step, where the force applying pillar pushes the magnetic device by passing through a jig hole on the base, thereby causing the top part of the magnetic device to cooperate in a contacting manner with the positioning structure.

According to another aspect of the present disclosure, a fabrication method of a magnetic component includes the following steps:
a step of providing a magnetic device, where the magnetic device has a top part and a bottom part arranged opposite to each other, and the magnetic device includes a magnetic core and a winding wound around the magnetic core;
a step of providing a base, where the base includes a base plate;
a step of providing an assembly jig, where the assembly jig includes a force applying pillar, a positioning structure and a cylindrical wall, one end of the cylindrical wall is connected to a peripheral edge of the base plate, such that the cylindrical wall and the base plate enclose an accommodating space; and the positioning structure is arranged in the accommodating space, and located at another end of the cylindrical wall away from the base plate; and
a positioning step, where the magnetic device is arranged inside the cylindrical wall, and the force applying pillar pushes the magnetic device by passing through a jig hole on the base, thereby causing the top part of the magnetic device to cooperate in a contacting manner with the positioning structure.

The embodiments of the present disclosure have the following advantages or beneficial effects.

The magnetic component of the present disclosure is provided with the positioning frame or the assembly jig, and the top part of the magnetic device is in contact with the positioning part of the positioning frame or the positioning structure of the assembly jig, which shortens the distance between the top part of the magnetic component and the heat dissipation aluminum plate of the client, i.e., the heat dissipation channel is shortened, and thus the heat dissipation effect is enhanced. On the other hand, the positioning frame or the assembly jig and the base plate jointly enclose an accommodating space, and the magnetic device is located in the accommodating space, which makes the overall height of the magnetic component determined, i.e., the sum of the height of the positioning frame or the assembly jig and the height of the base plate. Therefore, the overall heights of a plurality of magnetic components are consistent, and the lengths of the heat dissipation channels are determined, resulting in good consistency of the heat dissipation effects of the magnetic components.

### BRIEF DESCRIPTION OF THE DRAWINGS

The foregoing and other features and advantages of the present disclosure will become more apparent by describing in detail exemplary embodiments of the present disclosure with reference to the accompanying drawings.

FIG. 1 shows a comparative diagram of heat dissipation channels of two magnetic components with different winding tolerances in a fabrication method of the magnetic component in the related art.

FIG. 2A is a schematic diagram of a three-dimensional structure of a magnetic component in some embodiments of the present disclosure viewed from an angle.

FIG. 2B is a three-dimensional exploded view of a magnetic component in some embodiments of the present disclosure.

FIG. 2C is a schematic diagram of a three-dimensional structure of a magnetic component in some embodiments of the present disclosure viewed from another angle.

FIG. 2D is a three-dimensional cross-sectional view of a magnetic component in some embodiments of the present disclosure.

FIG. 3 is a three-dimensional diagram of a positioning frame of a magnetic component in some embodiments of the present disclosure.

FIG. 4 is a cross-sectional view of a magnetic component in some embodiments of the present disclosure.

FIG. 5 is a cross-sectional view of a magnetic component in some embodiments of the present disclosure.

FIG. 6 is a cross-sectional view of a magnetic component in some embodiments of the present disclosure.

FIG. 7 is a cross-sectional view of a magnetic component in some embodiments of the present disclosure.

FIG. 8 is a cross-sectional view of a magnetic component in some embodiments of the present disclosure.

FIG. 9 shows a comparative diagram of heat dissipation channels of two magnetic components with different winding tolerances in some embodiments of a fabrication method of the magnetic component of the present disclosure.

FIG. 10 shows an exploded view of a magnetic component and an assembly jig in some embodiments of a fabrication method of the magnetic component of the present disclosure.

FIG. 11 shows a three-dimensional diagram of a positioning frame of a magnetic component in some embodiments of a fabrication method of the magnetic component of the present disclosure.

FIG. 12 shows an exploded view of a magnetic component and an assembly jig in some embodiments of a fabrication method of the magnetic component of the present disclosure.

FIG. 13 shows a three-dimensional diagram of a portion of an assembly jig in some embodiments of a fabrication method of the magnetic component of the present disclosure.

FIG. 14 shows a three-dimensional cross-sectional view of a portion of an assembly jig in some embodiments of a fabrication method of the magnetic component of the present disclosure.

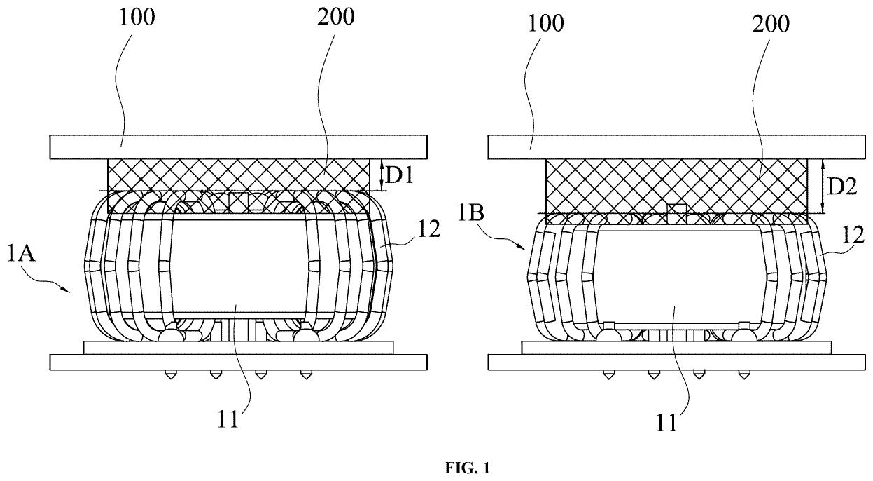

### DETAILED DESCRIPTION

Exemplary embodiments are now described more comprehensively with reference to the accompanying drawings. However, the exemplary embodiments are capable of being implemented in a variety of forms, and should not be construed as being limited to the embodiments set forth herein. Rather, the provision of these embodiments allows for the present disclosure to be comprehensive and complete, and conveys the idea of the exemplary embodiments in a comprehensive manner to those skilled in the art. The same reference numerals in the drawings indicate the same or similar structures, and therefore their detailed descriptions will be omitted.

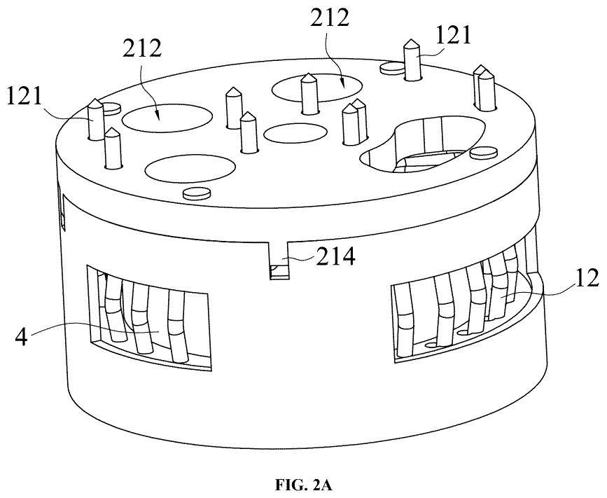

As shown in FIGS. 2A-2D, the magnetic component in some embodiments of the present disclosure includes a magnetic device 1, a base 2 and a positioning frame 3. It should be noted that the magnetic component is installed upside down in FIG. 2A, FIG. 2B and FIG. 2D.

The magnetic device 1 has a top part 13 and a bottom part 14 arranged opposite to each other, and a central through hole. The magnetic device 1 includes a magnetic core 11 and a winding 12 wound around the magnetic core 11.

The winding 12 is provided with a plurality of terminals 121. The winding 12 has a bottom surface and a top surface arranged opposite to each other, and the bottom surface and the top surface of the winding 12 correspond to the bottom part 14 and the top part 13 of the magnetic device 1 respectively.

The magnetic core 11 has a bottom surface and a top surface arranged opposite to each other, and the bottom surface and the top surface correspond to the bottom part 14 and the top part 13 of the magnetic device 1 respectively. In other word, in FIG. 2B, the bottom surface of the magnetic core 11 is close to the bottom part 14, and the top surface of the magnetic core 11 is close to the top part 13. In some embodiments of the present disclosure, as shown in FIGS. 2A-2D, the magnetic core is a toroidal magnetic core.

The base 2 includes a base plate 21, and a central pillar 22 extending perpendicularly from a central region of the base plate 21. A plurality of through holes, such as terminal holes 211, jig holes 212, and adhesive filling holes 213, may be provided on the base 2.

At least one isolation plate 221 may be provided on the central pillar 22 along a circumferential direction of the central pillar 22. The isolation plate 221 is used to isolate different windings to meet safety requirements. The central pillar 22 is provided with a through adhesive filling flow channel. The adhesive filling flow channel is communicated with the adhesive filling hole 213 on the base 2. An adhesive may be filled into the magnetic component through the adhesive filling hole 213 and the adhesive filling flow channel.

In some other embodiments, the base 2 may include only the base plate 21, but does not include the central pillar 22. The corresponding magnetic device 1 may not have to be provided with the central through hole.

The positioning frame 3 has a peripheral wall 31 and a positioning part, and in some embodiments, the positioning frame 3 is in a cylindrical shape. The peripheral wall 31 may be provided with a heat dissipation opening 30. The peripheral wall 31 has a first end and a second end that are opposite to each other, where the first end and the second end correspond to the top part and the bottom part of the magnetic device respectively, and the peripheral wall 31 is perpendicularly connected to a peripheral edge of the positioning part via the first end; and the second end of the peripheral wall 31 is connected to a peripheral edge of the base plate 21, causing the positioning frame 3 and the base plate 21 to jointly enclose an accommodating space. It should be noted that the perpendicularly direction of the perpendicularly connect is direction H perpendicular to the base plate 21.

The connection between the peripheral wall 31 and the base plate 21 may be in various ways. For example, a plurality of positioning notches 32 may be provided at the second end of the peripheral wall 31, a plurality of positioning bosses 214 may be provided on the base plate 21, and the peripheral wall 31 may be connected to the base plate 21 through the cooperation between the plurality of positioning notches 32 and the plurality of positioning bosses 214.

When the magnetic component in some embodiments of the magnetic component of the present disclosure is assembled, the central pillar 22 of the base 2 extends through the central through hole of the magnetic device 1 from the bottom part 14 of the magnetic device 1, and the plurality of terminals 121 protrude from corresponding terminal holes 211 on the base plate 21 of the base 2 respectively; and the magnetic device 1 is installed in the accommodating space enclosed by the positioning frame 3 and the base plate 21, and the top part 13 of the magnetic device 1 is caused to cooperate in a contacting manner with the positioning part of the positioning frame 3.

The magnetic component of the present disclosure is provided with the positioning frame 3, and the top part 13 of the magnetic device 1 cooperates in a contacting manner with the positioning part of the positioning frame 3, i.e., the top part of the magnetic component is used for positioning, which makes it easy to control the consistency of the distances between the top parts of a plurality of magnetic components and the heat dissipation aluminum plate of the client, resulting in good consistency of the heat dissipation effects of the plurality of magnetic components.

The following examples illustrate the specific manner in which the top part 13 of the magnetic device 1 cooperates in a contacting manner with the positioning part of the positioning frame 3 in the present disclosure.

As shown in FIG. 2B and FIG. 2D, the magnetic component further includes a protection box 4. The protection box 4 wraps the outer surface of the magnetic core 11 to protect the magnetic core 11. The protection box 4 has a bottom surface and a top surface arranged opposite to each other, and the bottom surface and the top surface of the protection box 4 correspond to the bottom part 14 and the top part 13 of the magnetic device 1 respectively. The top surface of the protection box 4 is provided with a protruding rib 42.

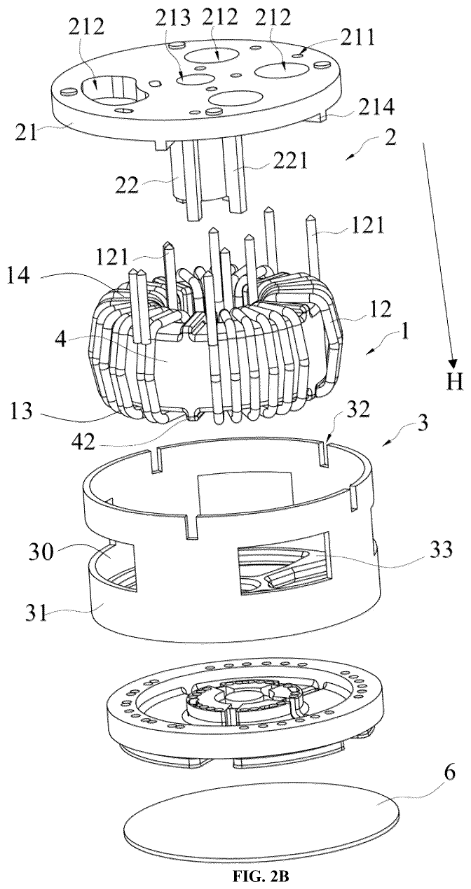

As shown in FIG. 3, the positioning part of the positioning frame 3 includes a plurality of radially arranged positioning ribs 33.

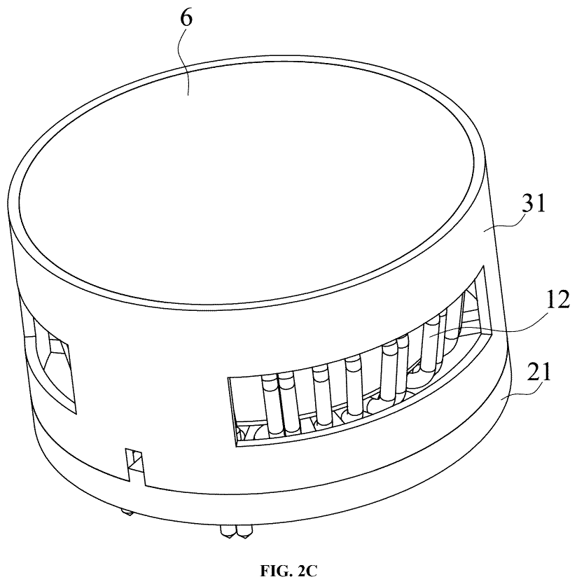

As shown in FIG. 4, a total height of the protruding rib 42 of the protection box 4 and the positioning rib 33 of the positioning frame 3 in a direction H perpendicular to the base plate 21 is greater than a height of the winding 12 protruding from the top surface of the protection box 4. The protruding rib 42 of the protection box 4 cooperates in a contacting manner with the positioning rib 33 of the positioning frame 3, thereby causing the cooperation between the top part 13 of the magnetic device 1 and the positioning part of the positioning frame 3.

In the embodiment shown in FIG. 4, since the sum of the height of the protruding rib 42 and the height of the positioning rib 33 is greater than the height of the winding 12 protruding from the top surface of the protection box 4, and the positioning of the top part 13 of the magnetic device 1 is achieved by the contacting cooperation between the protruding rib 42 and the positioning rib 33, the winding tolerance of the winding 12 is effectively shielded, the heights of the magnetic components are consistent, and the distances between the top parts of the magnetic components and the heat dissipation aluminum plate of the client are consistent, ensuring consistent heat dissipation effects.

In some other embodiments, the bottom surface of the protection box 4 may also be provided with a protruding rib 42. In this way, there is no need to differentiate the orientation of the protection box 4 during assembly, i.e., whether the top surface of the protection box 4, or the bottom surface of the protection box 4 faces the positioning part, the contacting cooperation between the protruding rib 42 and the positioning rib 33 can be achieved. As a result, the magnetic component can be assembled more conveniently and quickly.

In some other embodiments, as shown in FIG. 2B, FIG. 2C, and FIG. 2D, the magnetic component further includes an insulating structure 6. The insulating structure 6 is arranged at the top part of the magnetic component. Through the insulating structure 6, a good heat dissipation effect can be ensured and a reliable safety insulating performance can be achieved. On the other hand, the insulating structure 6 can also increase the safety distance from the winding to the heat dissipation aluminum plate.

The insulating structure 6 may be a metal plate plus an insulating sheet structure, where the material of the metal plate may be aluminum, copper, stainless steel, or other materials with good thermal conductivity. The insulating sheet may be attached to the outer surface of the metal plate. The insulating sheet may be a high-temperature insulating tape, a Nomex paper, an epoxy resin sheet, or other thin sheets that are resistant to high voltages and have good insulating properties. The insulating structure 6 may also be an aluminum-based circuit board. The insulating structure 6 may also be a thermally conductive insulating material such as an alumina ceramic, an aluminum nitride ceramic, a boron nitride ceramic, a thermally conductive plastic, and a thermally conductive silicone sheet with an insulating layer.

Typically, an area of a projection of the insulating structure 6 on a heat dissipation plane (a plane perpendicular to the central axis of the magnetic component), e.g., the top surface of the magnetic component, is larger than an area of a projection of the winding on this plane, ensuring that the winding is insulated from the heat dissipation aluminum plate.

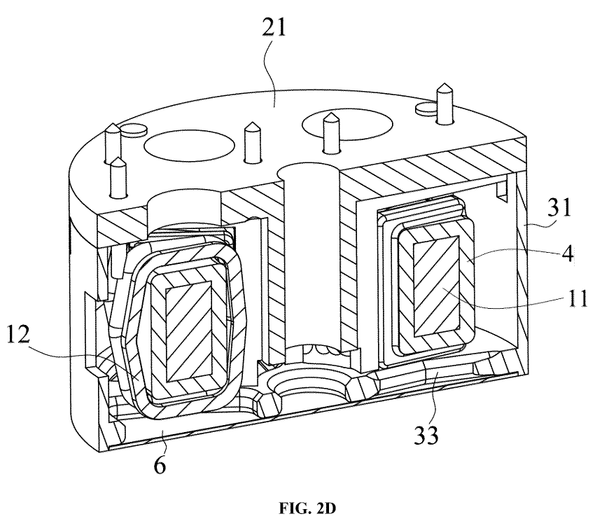

As shown in FIG. 5, in some embodiments of the present disclosure, the magnetic component further includes a thermally conductive adhesive layer 5, and the thermally conductive adhesive layer 5 wraps the top part 13 of the magnetic device 1 and fills a gap between the winding 12 and the protection box 4; further, the thermally conductive adhesive layer 5 wraps a portion of the protection box 4 or even wraps the entire magnetic device 1.

Due to the addition of the thermally conductive adhesive layer 5, the heat generated by the magnetic component can be exported outward more quickly, which is conducive to improving the heat dissipation efficiency.

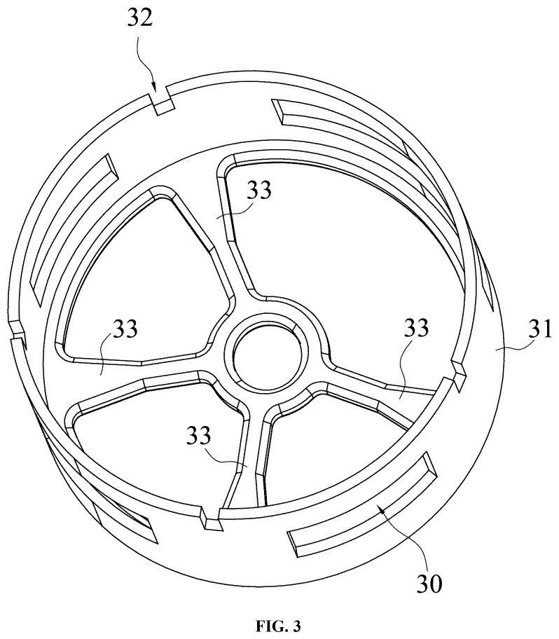

As shown in FIG. 6, in some embodiments of the present disclosure, the protection box 4 is not provided with the protruding rib 42, and the top surface of the protection box 4 cooperates in a contacting manner with the positioning rib 33. The height of the positioning rib 33 in the direction H perpendicular to the base plate 21 is greater than the height of the winding 12 protruding from the top surface of the protection box 4. The winding 12 protruding from the top surface of the protection box 4 is accommodated between two adjacent positioning ribs 33.

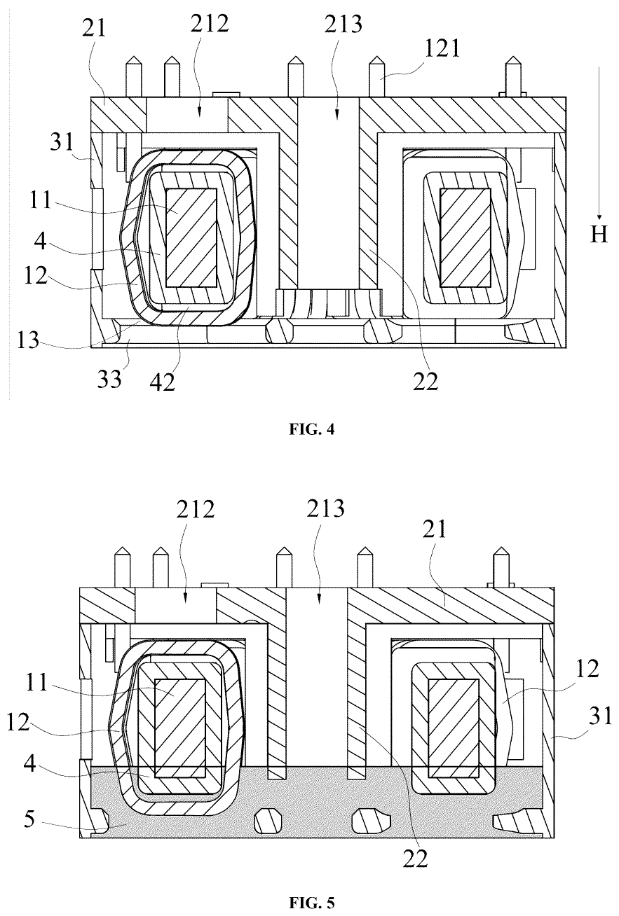

As shown in FIG. 7, in some embodiments of the present disclosure, the magnetic core 11 is not wrapped with the protection box 4 on the outer side of the magnetic core 11, and the top surface of the magnetic core 11 cooperates in a contacting manner with the positioning rib 33 of the positioning frame 3. The height of the positioning rib 33 of the positioning frame 3 in the direction perpendicular to the base plate 21 is greater than the height of the winding 12 protruding from the top surface of the magnetic core 11. The winding 12 protruding from the top surface of the magnetic core 11 is accommodated between two adjacent positioning ribs 33.

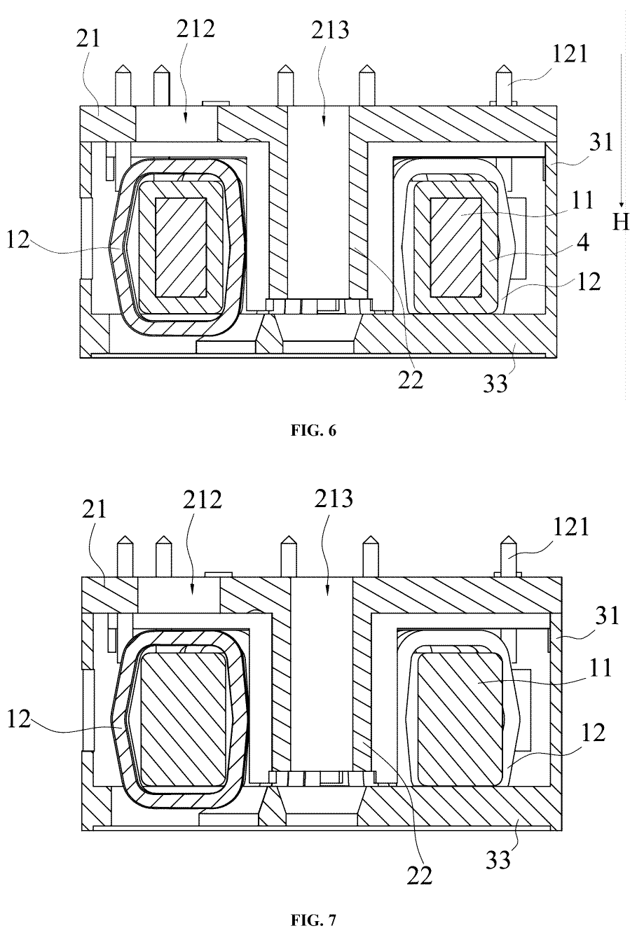

As shown in FIG. 8, in some embodiments of the present disclosure, the top surface of the winding 12 cooperates in a contacting manner with the positioning part of the positioning frame 3, such as the positioning rib 33. A distance S is provided between the bottom surface of the winding 12 and the base plate 21. In other embodiments, the bottom surface of the winding 12 may also cooperate in a contacting manner with the base plate 21.

The fabrication method of a magnetic component in some embodiments of the present disclosure includes the following steps:
a step of providing a magnetic device 1, where the magnetic device 1 has a top part 13 and a bottom part 14 arranged opposite to each other, and the magnetic device 1 includes a magnetic core 11 and a winding 12 wound around the magnetic core 11; the magnetic core 11 has a bottom surface and a top surface arranged opposite to each other, and the bottom surface and the top surface of the magnetic core 11 correspond to the bottom part 14 and the top part 13 of the magnetic device 1 respectively; and the winding 12 has a bottom surface and a top surface arranged opposite to each other, and the bottom surface and the top surface of the winding 12 correspond to the bottom part 14 and the top part 13 of the magnetic device 1 respectively;
a step of providing a base 2, where the base 2 includes a base plate 21;
a step of providing a positioning frame 3, where the positioning frame 3 has a positioning part and a peripheral wall 31; the peripheral wall 31 includes a first end and a second end arranged opposite to each other, where the first end and the second end correspond to the top part and the bottom part of the magnetic device 1 respectively, and the peripheral wall 31 is perpendicularly connected to a peripheral edge of the positioning part via the first end; the second end of the peripheral wall 31 is connected to a peripheral edge of the base plate 21, thereby causing the positioning frame 3 and the base plate 21 to jointly enclose an accommodating space; and the magnetic device 1 is located in the accommodating space; and
a positioning step, where an assembly jig is used to push the magnetic device 1 by passing through a jig hole on the base 2, thereby causing the top part 13 of the magnetic device 1 to cooperate in a contacting manner with the positioning part of the positioning frame 13.

The fabrication method of the magnetic component in some embodiments of the present disclosure includes the step of providing the positioning frame 3, and the top part 13 of the magnetic device 1 is in contact with the positioning part of the positioning frame 3, i.e., the top part of the magnetic component is used for positioning, which makes it easy to control the consistency of the distances between the top parts of a plurality of magnetic components and the heat dissipation aluminum plate of the client, resulting in good consistency of the heat dissipation effects of the plurality of magnetic components.

In some embodiments, the magnetic device 1 is provided with a central through hole, the base 2 further includes a central pillar 22 arranged perpendicularly at a center of the base plate 21, and the central pillar 22 is arranged in the central through hole of the magnetic device 1 by passing through, from the bottom part 14 of the magnetic device 1, the central through hole.

In the positioning step of some embodiments, the top surface of the winding 12 is caused to cooperate in a contacting manner with the positioning part of the positioning frame 3.

In some embodiments, the positioning part of the positioning frame 3 includes a plurality of radially arranged positioning ribs 33, the magnetic core 11 has a bottom surface and a top surface arranged opposite to each other, and the bottom surface and the top surface of the magnetic core 11 correspond to the bottom part 14 and the top part 13 of the magnetic device 1 respectively; and in the positioning step, the top surface of the magnetic core 11 is caused to cooperate in a contacting manner with the positioning rib 33 of the positioning frame 3.

It should be noted that the assembly jig is removed after the assembly of the magnetic component is complete.

In some other embodiments for the fabrication method of a magnetic component of the present disclosure, the magnetic component further includes a protection box 4. The protection box 4 wraps the magnetic core 11 to protect the magnetic core 11. The protection box 4 has a bottom surface and a top surface arranged opposite to each other, and the bottom surface and the top surface of the protection box 4 correspond to the bottom part 14 and the top part 13 of the magnetic device 1 respectively.

The positioning part of the positioning frame 3 includes a plurality of radially arranged positioning ribs 33. The top surface of the protection box 4 is provided with protruding ribs 42. A total height of the protruding rib 42 and the positioning rib 33 in a direction H perpendicular to the base plate 21 is greater than a height of the winding 12 protruding from the top surface of the protection box 4.

In some embodiments, in the positioning step, the protruding rib 42 of the protection box 4 is caused to cooperate in a contacting manner with the positioning rib 33 of the positioning frame 3.

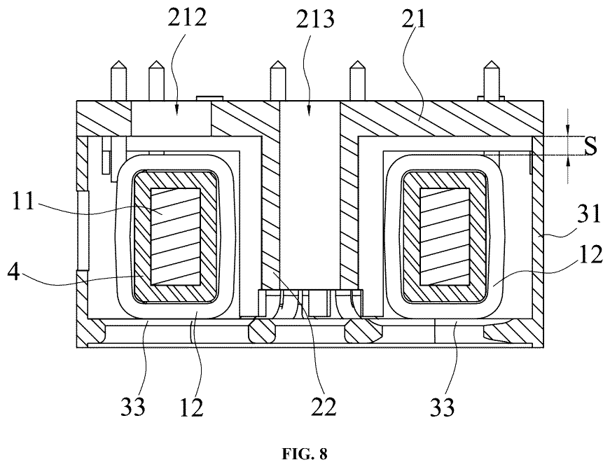

As shown in FIG. 9, the winding tolerances of the two windings in the two magnetic components are different, i.e., the winding 12 on the left side has a larger winding tolerance on the magnetic core 11, and the distance D1 between the top part of the winding 12 and the heat dissipation aluminum plate 100 of the client is smaller; and the winding 12 on the right side has a smaller winding tolerance on the magnetic core 11, and the distance D2 between the winding 12 and the heat dissipation aluminum plate 100 of the client is larger.

In the embodiment shown in FIG. 9, the top part of the magnetic component is used for positioning, specifically, through the contacting cooperation between the protruding rib 42 on the top surface of the protection box 4 and the positioning rib 33 of the positioning frame 3 located at the top part of the magnetic component, the winding 12 and the magnetic core 11 that generate large amounts of heat are made to be as close as possible to the top part of the magnetic component, i.e., as close as possible to the heat dissipation aluminum plate 100 of the client, which shortens the heat dissipation channel, improves the heat dissipation effect, and enables the thickness of the heat dissipation adhesive layer 200 of the client to be greatly reduced. Thus, the cost can be reduced.

On the other hand, as shown in FIG. 9, the distances between the two magnetic components with different winding tolerances and the heat dissipation aluminum plate 100 of the client are the same, both being D0, i.e., the lengths of the heat dissipation channels of the two magnetic components are the same, and the heat dissipation consistency is good; furthermore, the heights of the two magnetic components are the same, both being the sum of the thickness of the base plate and the height of the positioning frame. The fabrication method of this embodiment makes the height of each magnetic component precise, and makes the consistency of the heights of a plurality of magnetic components good. Using the bottom surface of each magnetic component as a reference during installation can ensure that the top surface of each magnetic component is at the same height, which is not only conducive to improving the heat dissipation effect, but also convenient to install.

In some other embodiments for the fabrication method, the top surface of the protection box 4 is not provided with the protruding rib 42, in which case, in the positioning step, the top surface of the protection box 4 is caused to cooperate in a contacting manner with the positioning part of the positioning frame 3; furthermore, when the positioning part includes a plurality of positioning ribs 33, the top surface of the protection box 4 is caused to cooperate in a contacting manner with the positioning rib 33.

In some other embodiments for the fabrication method, the base plate 21 is provided with a through adhesive filling hole 213 passing through the base plate 21, and the fabrication method further includes forming a thermally conductive adhesive layer 5 by filling the accommodating space with an adhesive through the adhesive filling hole 213, where the thermally conductive adhesive layer 5 at least wraps the top part 13 of the magnetic device 1, and fills a gap between the winding 12 and the magnetic core 11 or the protection box 4; further, the thermally conductive adhesive layer 5 may wrap the entire magnetic device 1.

In some other embodiments for the fabrication method, the magnetic device 1 is provided with a central through hole, the base 2 further includes a central pillar 22 extending perpendicularly from a central region of the base plate 21, and the central pillar 22 extends through the central through hole of the magnetic device 1 from the bottom part 14 of the magnetic device 1. The base plate 21 is provided with a through adhesive filling hole 213 passing through the base plate 21, the central pillar 22 is provided with an adhesive filling flow channel communicated with the adhesive filling hole 213, and the fabrication method further includes forming a thermally conductive adhesive layer 5 by filling the accommodating space with an adhesive through the adhesive filling hole 213 and the adhesive filling flow channel, where the thermally conductive adhesive layer 5 at least wraps the top part 13 of the magnetic device 1, and fills a gap between the winding 12 and the magnetic core 11 or the protection box 4; further, the thermally conductive adhesive layer 5 may wrap the entire magnetic device 1.

In some other embodiments for the fabrication method, the fabrication method further includes a step of removing the positioning frame 3.

The fabrication method of a magnetic component in some embodiments of the present disclosure includes the following steps:
a step of providing a magnetic device 1, where the magnetic device 1 has a top part 13 and a bottom part 14 arranged opposite to each other, and the magnetic device 1 includes a magnetic core 11 and a winding 12 wound around the magnetic core 11;
a step of providing a base 2, where the base 2 includes a base plate 21;
a step of providing a positioning frame 3, where the positioning frame 3 has a peripheral wall 31; the peripheral wall 31 includes a first end and a second end arranged opposite to each other, where the first end and the second end correspond to the top part and the bottom part of the magnetic device 1 respectively, and the second end is connected to a peripheral edge of the base plate 21, thereby causing the positioning frame 3 and the base plate 21 to jointly enclose an accommodating space; and the magnetic device 1 is located in the accommodating space;
a step of providing an assembly jig, where the assembly jig includes a positioning structure and a force applying pillar, and the peripheral wall 31 is perpendicularly connected to a peripheral edge of the positioning structure via the first end; and
a positioning step, where the force applying pillar pushes the magnetic device 1 by passing through a jig hole on the base 2, thereby causing the top part 13 of the magnetic device 1 to cooperate in a contacting manner with the positioning structure.

In some embodiments, the positioning frame 3 is not provided with the positioning part, and the positioning structure is provided on the assembly jig. In the positioning step, the top part 13 of the magnetic device 1 is caused to cooperate in a contacting manner with the positioning structure on the assembly jig.

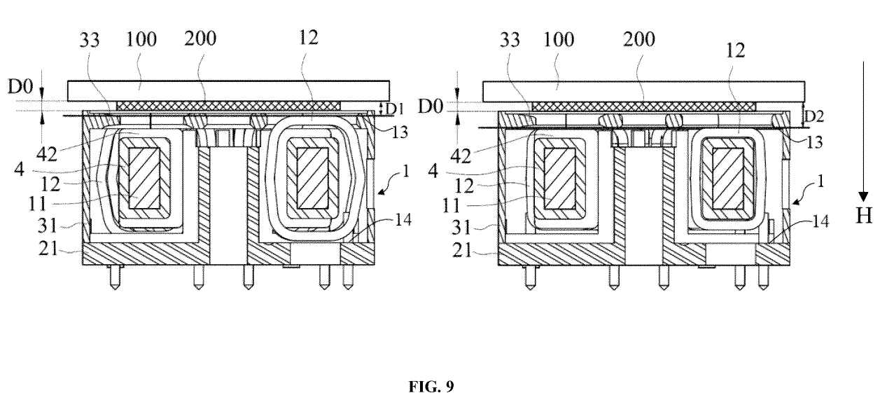

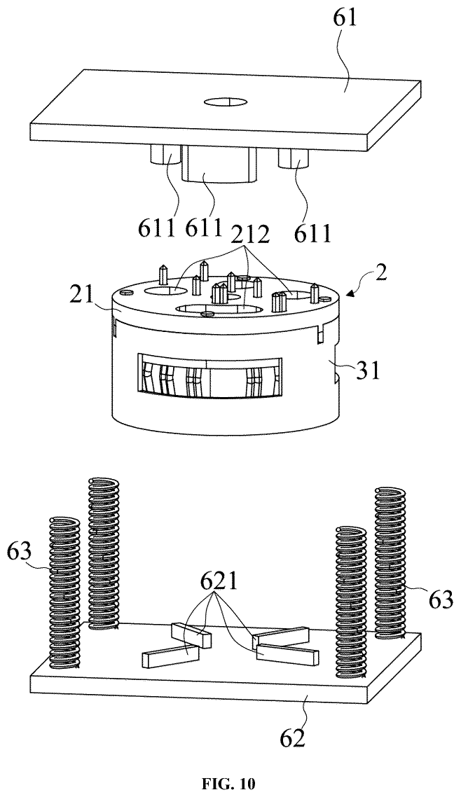

By way of example, as shown in FIGS. 10 and 11, the positioning frame 3 of the magnetic component includes only the peripheral wall 31, one end, with a notch 32, of the peripheral wall 31 is connected to the base plate 21 of the base 2, and the other end of the peripheral wall 31 is not provided with the positioning part.

As shown in FIG. 10, the assembly jig includes a first plate 61 and a second plate 62 arranged in parallel, and a spring 63 connecting the first plate 61 and the second plate 62. The first plate 61 is provided with the force applying pillar 611. The second plate 62 is provided with the positioning structure, such as a plurality of positioning strips 621 arranged radially. And the plurality of positioning strips 621 are configured as protruding portions.

In some embodiments, the assembly jig may further include a spring pillar connected between the first plate 61 and the second plate 62. The spring pillar is beneficial for maintaining the state of the assembly jig and preventing the first plate 61 and the second plate 62 from being displaced relative to each other in a post-fabrication process, such as adhesive filling and baking. In some embodiments, the assembly jig may not include the first plate 61, and the force applying pillar 611 may be an externally provided telescopic rod, etc. In some other embodiments, the assembly jig may not include the second plate 62, and the positioning structure may be arranged on some external support such as a support plate.

Please refer to FIG. 2B, and FIGS. 6-8, in the positioning step, the force applying pillar 611 pushes the magnetic device 1 by passing through the jig hole 212 on the base plate 21 of the base 2, thereby causing the top part 13 of the magnetic device 1, such as the top surface of the winding 12, magnetic core 11 or protection box 4 at the top part 13, or the protruding rib on the top surface of the protection box 4, to cooperate in a contacting manner with the positioning strip 621 on the assembly jig.

The fabrication method of a magnetic component in some embodiments of the present disclosure includes the following steps:
a step of providing a magnetic device 1, where the magnetic device 1 has a top part 13 and a bottom part 14 arranged opposite to each other, and the magnetic device 1 includes a magnetic core 11 and a winding 12 wound around the magnetic core 11;
a step of providing a base 2, where the base 2 includes a base plate 21;
a step of providing an assembly jig, where the assembly jig includes a force applying pillar 611, a positioning structure 621 and a cylindrical wall 64; one end of the cylindrical wall 64 is connected to a peripheral edge of the base plate 21, such that the cylindrical wall 64 and the base plate 21 enclose an accommodating space; and the positioning structure 621 is arranged in the accommodating space, and is located at another end of the cylindrical wall 64 away from the base plate 21; and
a positioning step, where the magnetic device 1 is arranged in the accommodating space, and the force applying pillar 611 pushes the magnetic device 1 by passing through a jig hole 212 on the base 2, thereby causing the top part 13 of the magnetic device 1 to cooperate in a contacting manner with the positioning structure 621.

In some embodiments, the magnetic component is not provided with the positioning frame, and correspondingly, the assembly jig is provided with the positioning structure 621 and a cylindrical wall 64. The cylindrical wall 64 and the base plate 21 enclose an accommodating space. In the positioning step, the magnetic device 1 is placed inside the accommodating space, and the force applying pillar 611 pushes the magnetic device 1 by passing through the jig hole 212 on the base, thereby causing the top part 13 of the magnetic device 1 to cooperate in a contacting manner with the positioning structure 621 on the assembly jig.

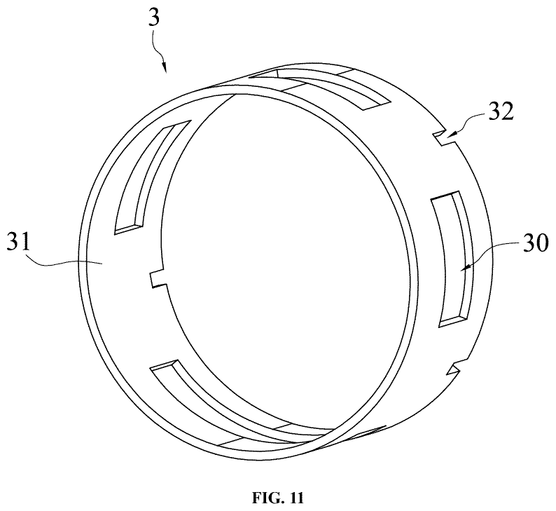

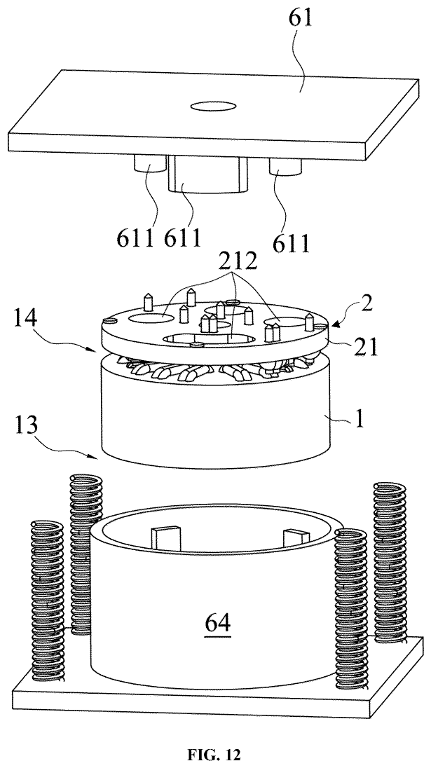

By way of example, as shown in FIGS. 12 and 13, the magnetic component does not include the positioning frame; and correspondingly, the assembly jig is provided with the positioning structure 621 and a cylindrical wall 64. In an embodiment, the cylindrical wall 64 may function similarly to the positioning frame in the magnetic component of the present disclosure, except that the cylindrical wall 64 is provided at a position on the assembly jig.

As shown in FIGS. 12 and 13, the assembly jig in some embodiments for fabrication method of the magnetic component of the present disclosure adds the cylindrical wall 64 to the assembly jig shown in FIG. 10, and the cylindrical wall 64 is fixed to the second plate 62 and contains the positioning strip 621 which serves as the positioning structure.

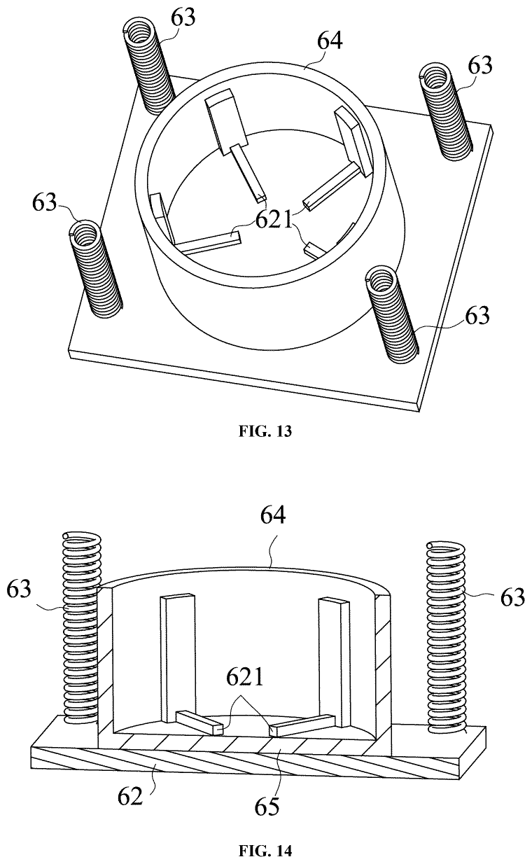

In another embodiment, as shown in FIG. 14, a sealing plate 65 is provided at the bottom end of the cylindrical wall 64. The sealing plate 65 is fixed to the second plate 62, and the positioning strip 621 is fixed to the sealing plate 65.

In addition, in each of the above embodiments for the fabrication method of the magnetic component, after the positioning step, a step of providing an insulating structure may be further included. The insulating structure is arranged at the top part of the magnetic component. Through the insulating structure, a good heat dissipation effect can be ensured and a reliable safety insulating performance can be achieved. On the other hand, the insulating structure can also increase the safety distance from the winding to the heat dissipation aluminum plate. The insulating structure may be a metal plate plus an insulating sheet structure, where the material of the metal plate may be aluminum, copper, stainless steel, or other materials with good thermal conductivity. The insulating sheet may be attached to the outer surface of the metal plate. The insulating sheet may be a high-temperature insulating tape, a Nomex paper, an epoxy resin sheet, or other thin sheets that are resistant to high voltages and have good insulating properties. The insulating structure may also be an aluminum-based circuit board. The insulating structure may also be a thermally conductive insulating material such as an alumina ceramic, an aluminum nitride ceramic, a boron nitride ceramic, a thermally conductive plastic, and a thermally conductive silicone sheet with an insulating layer. Typically, an area of a projection of the insulating structure on a heat dissipation plane (a plane perpendicular to the central axis of the magnetic component), e.g., the top surface of the magnetic component, is larger than an area of a projection of the winding on this plane, ensuring that the winding is insulated from the heat dissipation aluminum plate.

In the embodiments of the application, the terms “first”, “second”, “third” are used for descriptive purposes only and are not to be understood as indicating or implying relative importance; and the term “a plurality of” refers to two or more, unless otherwise expressly limited. The terms “install”, “connecting”, “connection”, “fix”, etc. should be understood in a broad sense, e.g., the term “connection” may be a fixed connection, a detachable connection, or an integrated connection; and the term “connecting” may be a direct connecting or an indirect connecting through an intermediate medium. For those ordinary skilled in the art, the specific meanings of the above terms in the embodiments of the application may be understood according to the specific situation.

In the description of the embodiments of the application, it should be understood that the terms “up”, “down”, “left”, “right”, “front”, “back”, etc. indicate orientations or positional relationships based on those shown in the accompanying drawings, and are only intended to facilitate the description of the embodiments of the application and to simplify the description, but are not intended to indicate or imply that the device or unit referred to must have a specific orientation, and be constructed and operated in a specific orientation. Therefore, the above terms are not to be understood as a limitation of the embodiments of the application.

In the description of this specification, the description of the terms “an embodiment”, “some embodiments”, “specific embodiments”, etc. means that the specific features, structures, materials, or characteristics described in conjunction with the embodiment or example are included in at least one embodiment or example of the embodiments of the application. In this specification, the illustrative expressions of the above terms may not necessarily refer to the same embodiment or example. Moreover, the specific features, structures, materials, or characteristics described may be combined in any one or more embodiments or examples in a suitable manner.

The above are only preferred embodiments of the embodiments of the application, and are not intended to limit the embodiments of the application. For those skilled in the art, the embodiments of the application may have various changes and variations. Any modifications, equivalent substitutions, improvements, etc. made within the spirit and principle of the embodiments of the application shall be included in the scope of protection of the embodiments of the application.

What is claimed is:

1. A magnetic component, comprising:
a magnetic device, comprising a top part and a bottom part arranged opposite to each other, wherein the magnetic device comprises a magnetic core and a winding wound around the magnetic core;
a base, comprising a base plate; and
a positioning frame, comprising a positioning part and a peripheral wall, wherein the peripheral wall comprises a first end and a second end arranged opposite to each other, the first end and the second end correspond to the top part and the bottom part of the magnetic device respectively, and the peripheral wall is perpendicularly connected to a peripheral edge of the positioning part via the first end; wherein
the second end is connected to a peripheral edge of the base plate, such that the positioning frame and the base plate enclose an accommodating space; the magnetic device is located in the accommodating space; and the top part of the magnetic device is in contact with the positioning part.

2. The magnetic component according to claim 1, wherein the magnetic device comprises a central through hole, the base further comprises a central pillar extending perpendicularly from a central region of the base plate, and the central pillar extends through the central through hole of the magnetic device from the bottom part of the magnetic device.

3. The magnetic component according to claim 2, wherein the magnetic core is a toroidal magnetic core.

4. The magnetic component according to claim 1, wherein the winding comprises a bottom surface and a top surface arranged opposite to each other; the bottom surface and the top surface of the winding correspond to the bottom part and the top part of the magnetic device respectively; and the top surface of the winding is in contact with the positioning part.

5. The magnetic component according to claim 4, wherein a distance is formed between the base plate and the bottom surface of the winding, or the base plate is in contact with the bottom surface of the winding.

6. The magnetic component according to claim 1, wherein the positioning part comprises a plurality of radially arranged positioning ribs.

7. The magnetic component according to claim 6, wherein the magnetic core comprises a bottom surface and a top surface arranged opposite to each other, the bottom surface and the top surface of the magnetic core correspond to the bottom part and the top part of the magnetic device respectively, a height of the positioning rib in a direction perpendicular to the base plate is greater than a height of the winding protruding from the top surface of the magnetic core, and the top surface of the magnetic core is in contact with the positioning rib of the positioning frame.

8. The magnetic component according to claim 6, further comprising a protection box, wherein the protection box wraps the magnetic core, the protection box comprises a bottom surface and a top surface arranged opposite to each other, the bottom surface and the top surface of the protection box correspond to the bottom part and the top part of the magnetic device respectively, and the top surface of the protection box is in contact with the positioning rib of the positioning frame.

9. The magnetic component according to claim 8, wherein the top surface of the protection box is provided with a protruding rib, a total height of the protruding rib and the positioning rib in a direction perpendicular to the base plate is greater than a height of the winding protruding from the top surface of the protection box, and the protruding rib is in contact with the positioning rib of the positioning frame.

10. The magnetic component according to claim 1, wherein the magnetic component further comprises a thermally conductive adhesive layer, and the base plate comprises an adhesive filling hole passing through the base plate, wherein the thermally conductive adhesive layer is formed in the accommodating space via the adhesive filling hole, and the thermally conductive adhesive layer at least wraps the top part of the magnetic device, and fills a gap between the winding and the magnetic core.

11. The magnetic component according to claim 2, wherein the magnetic component further comprises a thermally conductive adhesive layer, the base plate comprises an adhesive filling hole passing through the base plate, and the central pillar comprises an adhesive filling flow channel communicated with the adhesive filling hole, wherein the thermally conductive adhesive layer is formed in the accommodating space via the adhesive filling hole and the adhesive filling flow channel, and the thermally conductive adhesive layer at least wraps the top part of the magnetic device, and fills a gap between the winding and the magnetic core.

12. The magnetic component according to claim 1, wherein a positioning notch is provided at the second end, and the base plate is provided with a positioning boss cooperating with the positioning notch.

13. The magnetic component according to claim 1, wherein the base plate comprises a terminal hole and a jig hole.

14. The magnetic component according to claim 1, further comprising an insulating structure, wherein the insulating structure is arranged at the top part of the magnetic device.

15. A fabrication method of a magnetic component, comprising:
providing a magnetic device, wherein the magnetic device comprises a top part and a bottom part arranged opposite to each other, and the magnetic device comprises a magnetic core and a winding wound around the magnetic core;
providing a base, wherein the base comprises a base plate;
providing a positioning frame, wherein the positioning frame comprises a positioning part and a peripheral wall; wherein the peripheral wall comprises a first end and a second end arranged opposite to each other, the first end and the second end correspond to the top part and the bottom part of the magnetic device respectively, and the peripheral wall is perpendicularly connected to a peripheral edge of the positioning part via the first end; the second end of the peripheral wall is connected to a peripheral edge of the base plate, such that the positioning frame and the base plate enclose an accommodating space; and the magnetic device is located in the accommodating space; and
a positioning step, wherein an assembly jig is configured to push the magnetic device by passing through a jig hole on the base, such that the top part of the magnetic device is in contact with the positioning part.

16. The fabrication method according to claim 15, wherein the magnetic device comprises a central through hole, the base further comprises a central pillar extending perpendicularly from a central region of the base plate, and the central pillar extends through the central through hole of the magnetic device from the bottom part of the magnetic device.

17. The fabrication method according to claim 15, wherein the winding comprises a bottom surface and a top surface arranged opposite to each other, the bottom surface and the top surface of the winding correspond to the bottom part and the top part of the magnetic device respectively; and in the positioning step, the top surface of the winding is configured to be in contact with the positioning part.

18. The fabrication method according to claim 15, wherein the positioning part comprises a plurality of radially arranged positioning ribs, the magnetic core comprises a bottom surface and a top surface arranged opposite to each other, the bottom surface and the top surface of the magnetic core correspond to the bottom part and the top part of the magnetic device respectively; and in the positioning step, the top surface of the magnetic core is configured to be in contact with the positioning rib of the positioning frame.

19. The fabrication method according to claim 15, wherein the magnetic component further comprises a protection box, the protection box wraps the magnetic core, the protection box comprises a bottom surface and a top surface arranged opposite to each other, the bottom surface and the top surface of the protection box correspond to the bottom part and the top part of the magnetic device respectively; and in the positioning step, the top surface of the protection box is configured to be in contact with the positioning part of the positioning frame.

20. The fabrication method according to claim 19, wherein the positioning part comprises a plurality of radially arranged positioning ribs, the top surface of the protection box is provided with a protruding rib, and a total height of the protruding rib and the positioning rib in a direction perpendicular to the base plate is greater than a height of the winding protruding from the top surface of the protection box; and in the positioning step, the protruding rib is configured to be in contact with the positioning rib of the positioning frame.

21. The fabrication method according to claim 15, wherein the base plate comprises an adhesive filling hole passing through the base plate, and the fabrication method further comprises:
forming a thermally conductive adhesive layer by filling the accommodating space with an adhesive through the adhesive filling hole, wherein the thermally conductive adhesive layer at least wraps the top part of the magnetic device, and fills a gap between the winding and the magnetic core.

22. The fabrication method according to claim 16, wherein the base plate of the base comprises an adhesive filling hole passing through the base plate, the central pillar of the base comprises an adhesive filling flow channel communicated with the adhesive filling hole, and the fabrication method further comprises:
forming a thermally conductive adhesive layer by filling the accommodating space with an adhesive through the adhesive filling hole and the adhesive filling flow channel, wherein the thermally conductive adhesive layer at least wraps the top part of the magnetic device, and fills a gap between the winding and the magnetic core.

23. The fabrication method according to claim 21, further comprising removing the positioning frame.

24. The fabrication method according to claim 15, after the positioning step, further comprising providing an insulating structure, wherein the insulating structure is arranged at the top part of the magnetic device.
